(19) United States
(12) Patent Application Publication
(10) Pub. No.: US 2002/0090539 A1
(43) Pub. Date: Jul. 11, 2002

(54) Hydrogen-powered energy-producing device and system for continous production of hydrogen

(76) Inventors: John Paul Getty, Oak Ridge, TN (US); Jonathan Woodward, Knoxville, TN (US)

Correspondence Address: Shelley L. Stafford, UT-Battelle, LLC, P.O. Box 2008, Oak Ridge, TN, 37831-6498, US

(21) Appl. No.: 09/808,507

(22) Filed: Mar. 14, 2001

Related U.S. Application Data
(63) Continuation-in-part of application No. 09/675,870, filed on Sep. 29, 2000.

(51) Int. Cl. H01M 8/06; F28D 1/00

(52) U.S. Cl. 429/19; 422/198

(57) ABSTRACT

The present invention is an energy-producing device powered by a system for the continuous production of hydrogen comprising a reaction chamber containing reactant components under anaerobic conditions whereby hydrogen is continually produced when the reactant components react with one another. The device further comprises a fuel cell adjacent the reaction chamber wherein the hydrogen produced is to be used as fuel and is diffused into the fuel cell; the fuel cell has positive and negative electrodes to convert the hydrogen into energy. The present invention also includes a hydrogen-generating system for the continuous and sustained production of hydrogen.

### CROSS-RELATED APPLICATIONS

The present application is a continuation-in-part application to U.S. application Ser. No. 09/675,870 filed Sep. 29, 2000, incorporated herein by reference.

The invention was made with government support under contract no. DE-AC05-96OR22464 awarded by the United States Department of Energy to Lockheed Martin Energy Research Corporation; and the government has certain rights in the invention.

### FIELD OF THE INVENTION

The present invention relates to an energy-producing device having a continuous source of fuel in which to operate, particularly a hydrogen-powered energy-producing device fueled by a system for the continuous production of hydrogen based on a hydrogen-producing reaction cycle wherein the metal catalyst is regenerated.

### BACKGROUND OF THE INVENTION

The use of hydrogen as an alternative fuel or power source is receiving wide attention in both political and technical arenas. There is a need for the efficient production of hydrogen for use as a fuel in both vehicular and stationary engines and fuel cell systems. One reason for this attention lies in the ability of hydrogen to burn cleanly without producing any toxic by-products. While hydrogen is a clean and renewable energy resource, it is both expensive to produce in a pure form and unsafe to store in quantity due to its combustibility. Moreover, hydrogen is expensive and heavy when stored in containers of practical size.

It is known that electropositive elements with a greater negative standard electrode potential than hydrogen displace hydrogen from water or aqueous solutions of acid or alkali. This principle forms the basis of metal displacement reactions used in the preparation of hydrogen in the laboratory. However, because the metal is consumed during the reaction, this process is cost prohibitive. Also, the conversion rate of the reaction is extremely low unless the water or aqueous solution has been heated to very high temperatures which results in a low overall efficiency and thus it has no current practical commercial utility. Therefore, it is not a practical method of hydrogen production from an industrial point of view. If the metal could be regenerated easily, then such metal displacement reactions could have practical uses beyond preparation of hydrogen in the laboratory.

One example of generating hydrogen based upon the reaction is disclosed in U.S. Pat. No. 4,547,356 by Papineau. Papineau suggested that hydrogen may be generated by the catalytic decomposition of steam at temperatures of 1000° to 2000° F. (540° to 1094° C.) to form hydrogen and supposedly oxygen. Papineau contends that at those temperatures, the steam will disassociate in the presence of “a catalyst of a web-like cellular structure defined by interconnected metal filaments comprising iron, copper, silver, nickel, palladium, platinum, or iron-nickel and molybdenum” and that the hydrogen can then be separated from the oxygen with a diffusion-based separation membrane, e.g. palladium. Water or steam is thermodynamically incapable of decomposing into hydrogen and oxygen within the stated temperatures. Papineau continues to assert that more hydrogen will be produced by the process than will be required for reactivating the catalyst when it has become deactivated because of use.

Another example of generating hydrogen based upon this same reaction is disclosed in U.S. Pat. No. 5,510,201 by Werth. Werth disclosed a system for generating hydrogen at a faster rate by reacting particles of an activated iron reactant with heated water (up to 450° C.) in a fluidized bed-type reactor. The reaction results in an increased rate of hydrogen production along with spent metal oxide particles. Werth's method and system utilizes the heated water to reduce the metal oxide back to metal to recharge the system.

### OBJECTS OF THE INVENTION

Accordingly, it is an object of the present invention to provide an energy-producing device such as a power cell, a fuel cell or a heat engine fueled by a system for the continuous production of hydrogen for use as a clean fuel in the energy-producing device.

It is another object of the present invention to provide a new and improved energy-producing device having an enclosed system for the continuous production of hydrogen fuel.

It is a further object of the present invention to provide a hydrogen generating system, which is easy and relatively inexpensive to regenerate.

It is yet a further object of the present invention to provide a new and improved system for the continuous and sustained production of hydrogen for use as a clean fuel in an energy-producing device such as a power cell, fuel cell or a heat engine.

It is still yet a further object of the present invention to provide an energy-producing device such as a power cell or a heat engine fueled by a system for the continuous and sustained production of hydrogen for use as a clean fuel in an energy-producing device.

Further and other objects of the present invention will become apparent from the description contained herein.

### SUMMARY OF THE INVENTION

In accordance with one aspect of the present invention, the foregoing and other objects are achieved by an energy-producing device powered by a system for the continuous production of hydrogen comprising a reaction chamber containing reactant components under anaerobic conditions whereby hydrogen is continually produced when the reactant components react with one another. The device further comprises a fuel cell adjacent the reaction chamber wherein the hydrogen produced is to be used as fuel and is diffused into the fuel cell; the fuel cell has positive and negative electrodes to convert the hydrogen into energy.

In accordance with another aspect of the present invention, other objects are achieved by an energy-producing device comprising a reaction chamber and a fuel cell. The reaction chamber is enclosed within a housing and is adapted for supporting and maintaining an anaerobic environment. The reaction chamber contains reactant components whereby hydrogen is continually produced upon the reactant components reacting with one another. The fuel cell is enclosed within the housing as well. The fuel cell is contiguous with the reaction chamber wherein the reaction chamber is open to the fuel cell and whereby the hydrogen produced within the reaction chamber is diffused into the fuel cell to be used as fuel for generating energy. The fuel cell has positive and negative electrodes to convert the hydrogen into energy.

In accordance with yet another aspect of the present invention, other objects are achieved by a hydrogen-generating system for the continuous and sustained production of hydrogen fuel comprising a reaction vessel, a stock solution reservoir, a waste solution reservoir and a thermal means. The reaction vessel is adapted for supporting and maintaining an anaerobic environment and contains reactant components whereby hydrogen is continually produced upon the reactant components reacting with one another. The reaction vessel has a carrier gas inlet port to allow a carrier gas to enter the reaction vessel and a carrier gas outlet port to allow the carrier gas and hydrogen produced from the reaction to exit the reaction vessel. The reaction vessel further has a solution inlet port to allow a continuous flow of a stock solution to enter the reaction vessel so to continuously feed the reaction for the continuous and sustained production of hydrogen. The reaction vessel further has a solution outlet port to allow an overflow of excess solution within the vessel to exit the reaction vessel. The stock solution reservoir contains the stock solution and is in fluidic communication with the reaction vessel. The waste solution reservoir receives the overflow of excess solution exiting the reaction vessel and is in fluidic communication with the reaction vessel. The thermal means envelops the reaction vessel and maintains a constant reaction temperature within the reaction vessel.

### BRIEF DESCRIPTION OF THE DRAWINGS

In the drawings:

FIG. 1 illustrates the hydrogen production process via iron catalyst.

FIG. 2 is a schematic of the apparatus for measuring rates and yields of hydrogen evolution.

FIG. 3 shows a 15 mL reaction vessel with cover plates.

FIG. 4 shows the effect of iron powder mass on hydrogen production in 10 mM Hepes buffer degassed in nanopure water.

FIG. 5 shows the effect of solution degassing on rate of hydrogen production by iron powder in 10 mM Hepes buffer.

FIG. 6 shows the effect of rpm on rates of hydrogen production using 25 mg iron powder in 10 mL of degassed 1.0 M gluconic acid in nanopure water.

FIG. 7 shows the effect of temperature on rate of hydrogen production using 25 mg iron powder in 0.5 M degassed gluconic acid in nanopure water.

FIG. 8 shows the production of hydrogen from 25 mg iron powder in varying concentrations of degassed gluconic acid.

FIG. 9 shows the production of hydrogen by iron catalyst (265 mg) in 0.5 M degassed gluconic acid, pH 7.2 (15 mL).

FIG. 10 shows the oxidation of gluconic acid during the production of hydrogen from iron (265 mg iron powder in 15 mL 0.5 M degassed gluconic acid, pH 7.2).

FIG. 11 shows simultaneous production of hydrogen and oxygen gases using 25 mg iron powder in 10 mL 1 mM Hepes buffer.

FIG. 12 is a schematic of a 1.5 L reaction vessel and cover plate.

FIG. 13 is a schematic of the apparatus for measuring hydrogen production yields, rates by total gas collection.

FIG. 14a shows a fuel cell housing assembly from the front view.

FIG. 14b shows the fuel cell housing assembly from the top view.

FIG. 15 is an apparatus for hydrogen gas conversion to electrical energy (fuel cell with clock).

FIG. 16 illustrates a fuel cell with a 5 mL reaction chamber component.

FIG. 17 illustrates a prototype of a power cell having an enclosed fuel cell and reaction chamber within the power cell unit.

FIG. 18 shows a system for the continuous and sustained production of hydrogen.

For a better understanding of the present invention, together with other and further objects, advantages and capabilities thereof, reference is made to the following disclosure and appended claims in connection with the above-described drawings.

### DETAILED DESCRIPTION OF THE INVENTION

The present invention is based on sustainable hydrogen evolution by the reaction between a metal catalyst such as iron powder and water under anaerobic conditions in the presence of an organic acid such as gluconic acid. Iron is an active catalyst for the production of hydrogen gas under anaerobic conditions. In a moderately heated environment at ambient pressure, a degassed solution of an organic acid, such as gluconic acid dissolved in de-ionized water at close to neutral pH, is placed in contact with a metal catalyst such as iron powder and stirred continuously. Molecular hydrogen gas evolves from the reaction. The mechanism is given below:

3Fe+4H₂O→Fe₃O₄+8H⁺+8e⁻

8H⁺+8e⁻→4H₂ Eq. 1

The organic acid reduces the iron oxide formed and is recycled back to iron with the concomitant production of water molecules. The iron catalyst is thus restored and molecular hydrogen production becomes a continuous process.

Fe₃O₄+8C₆H₁₁O₇→3Fe+4H₂O+8C₆H₁₀O₇ Eq. 2

Gluconic acid (Sodium Gulconate) C₆H₁₀O₇Na

2-keto-D-Gluconic acid C₆H₁₀O₇

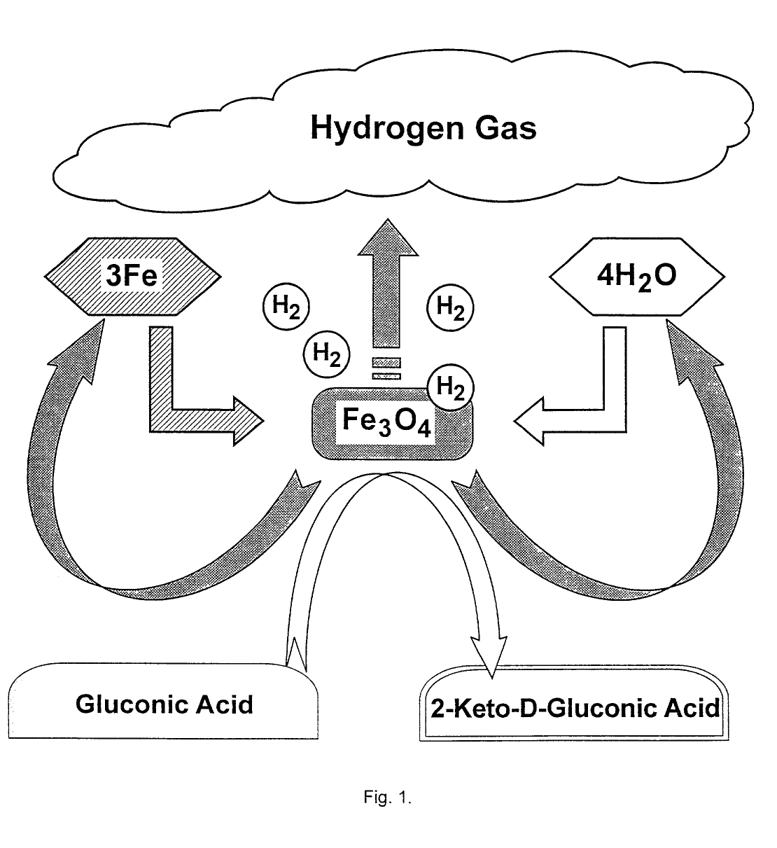

Gluconic acid is a renewable organic acid by virtue of its formation from sugar glucose (the most abundant source of carbon available) and is consumed during the process as it regenerates the iron catalyst necessary for molecular hydrogen production, FIG. 1. The standard free energies of these reactions are thermodynamically favorable.

Metal catalysts that can be used for Applicant's process include iron, aluminum, tin, copper, nickel and other metallic materials. Organic acids that can be used include gluconic acid, ascorbic acid, oxalic acid, citric acid, succinic acid, acetic acid and other organic acids that are comparable to gluconic acid in nature.

The generation of hydrogen was measured and analyzed in a specially constructed flow system as described below. For all experiments and EXAMPLES, iron powder was purchased from Aldrich (Milwaukee, Wis.), gluconic acid was from Sigma Chemical Co. (St. Louis, Mo.) and molecular sieves from Aldrich (Milwaukee, Wis.).

System for Hydrogen Analysis

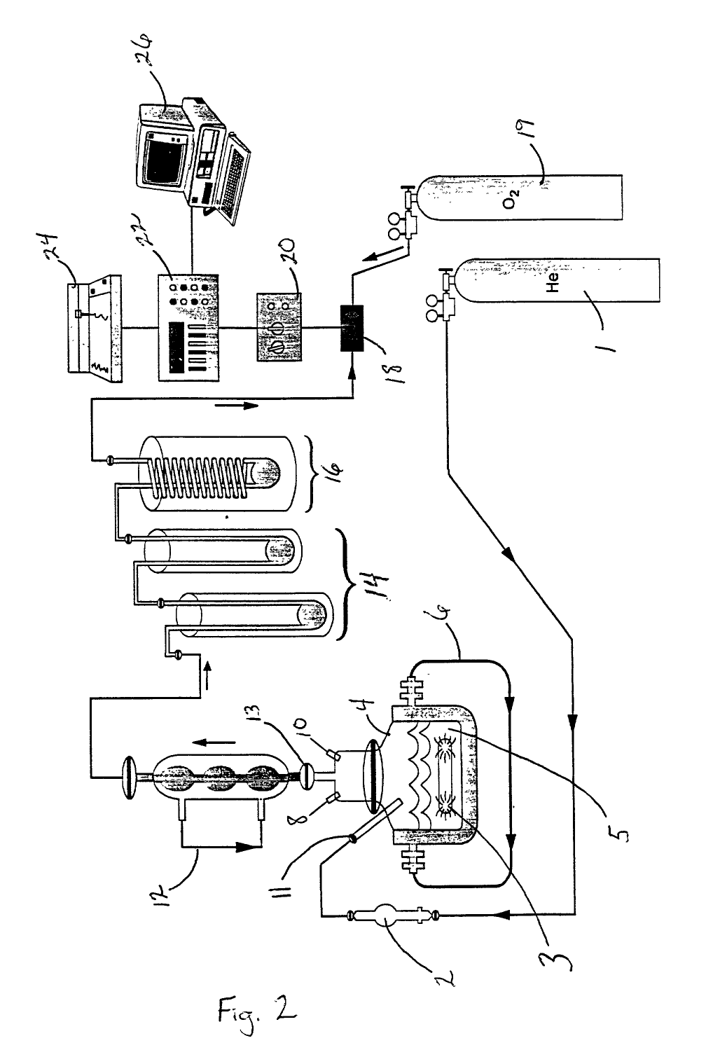

The schematic diagram of FIG. 2 outlines the flow system utilized for the purposes of hydrogen gas generation and analyses. The system begins with the carrier gas, namely helium, 1. The carrier gas 1 passes through the entire system and is responsible for the transportation of hydrogen gas from the place of reaction to the sensor 18. The flow rate of the carrier gas is proportional to the sensitivity of the hydrogen sensor and is set by the user. The first carrier gas interaction takes place in the electrolysis cell 2. The electrolysis cell 2 is filled with 2 mM potassium hydroxide (KOH) and serves two purposes. The first purpose is the hydration of the carrier gas 1 in order to minimize the drying effects in the reaction vessel 4. The second purpose is electrolysis of the KOH solution resulting in hydrogen production for the calibration of the hydrogen sensor 18. The carrier gas enters the reaction vessel 4 through the gas inlet 11, passes over the reaction components 3 (metal catalyst) and 5 (degassed aqueous organic acid solution) and exits the reaction vessel 4 through the gas outlet 13 (reaction vessel discussed below). The carrier gas enters the condensing chamber 12, which is in place for the minimization of reaction component evaporation. The carrier gas passes through two chilled sodium alumino-silicate microsieve drying traps 14 and one liquid nitrogen trap 16 for the removal of all gasses except hydrogen and helium. The carrier gas comes in contact with a hydrogen specific sensor 18, a tin-dioxide (SnO₂) semiconductor, changing the conductivity of the sensor. The oxygen reference gas 19 is applied to the sensor 18 at 100 ml/min for the restoration of the sensing element. The concentration of hydrogen present in the carrier gas determined by the change in conductivity, higher concentration equals higher conductivity. A simple electrical circuit converts the change in conductivity to an output signal. The output signal is transferred to an amplifier 20 then to a multi-meter 22. The output of the multi-meter 22 is registered on a recording chart 24 and data is collected by the computer code ASYST 26 (Technologies, Inc., Rochester, N.Y.). The data is analyzed by ASYST for hydrogen concentration and production rates.

The mechanics of the reaction vessel utilized and the kinetics explaining the catalytic abilities of the iron metal in order to generate molecular hydrogen, via consumption of renewable organic acids, are described separately.

Reaction Vessels for Hydrogen Production

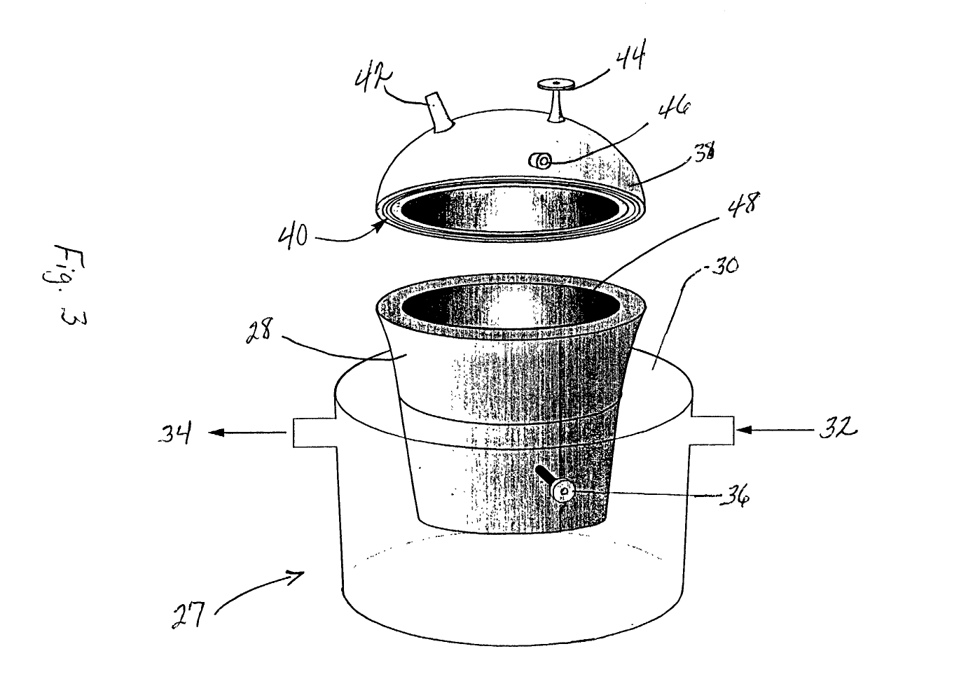

The vessel in which hydrogen generation takes place consists of several key features that support the overall reaction process, see FIG. 3. The reaction vessel 27 has two distinct parts: the main vessel body 28 and the cover plate 38. The design of the main vessel body 28 consists of an inner core chamber 48 where the reaction components are placed. The size and shape of the inner core chamber 48 is dependent on the dimensions and type of iron or metal catalyst (e.g. wire, chips, shavings, filings, powder, etc.) and the volume of organic solution(s) to be utilized. For example, the inner core chamber of a reaction vessel for iron wire and chips is 35 ml and for iron filings, and for iron powder, it is 15 ml.

The main vessel body 28 is enclosed by an outer core layer 30, which serves as a thermal heating system. The thermal layer 30 is present and required in order to maintain constant temperature throughout the entire hydrogen production process. The outer core layer 30 has a thermal heating jacket inlet 32 and a thermal heating jacket outlet 34. The cover plate 38 seals the inner core chamber 48 from the surrounding environment, creating a liquid/gas impermeable reaction chamber. FIG. 3 illustrates an o-ring seal 40. The vessel 27 is specifically designed to maintain an anaerobic environment at ambient pressure via the ports through which flow helium.

The 15 ml reaction vessel (FIG. 3) is equipped with four individual ports located either in the main vessel body 28 or the cover plate 38 that access the inner core chamber 48. One port is utilized for the injection and extraction of solutions 46; another is for insertion of a pH probe or monitoring device 42. The remaining two ports are for the passage of gases. One is for the influx of the carrier gas (e.g. helium) 36, and the other port is for the removal of the carrier gas as well as the generated hydrogen gas 44.

A stirring mechanism located within the reaction vessel 27 is responsible for the mixing of the reaction components (iron or other metal catalyst and organic acid solution). The stirring device is a simple Teflon-coated magnetic stirring bar that is inserted in the inner core chamber 48 and operated externally by a stirring plate, via magnetic forces (this is specific to the 15 ml reaction vessel).

Method for Hydrogen Production

Using the reaction vessel of FIG. 3 and the apparatus of FIG. 2, elemental iron or other metallic material such as aluminum, tin, copper or nickel, 3 is placed into the inner core chamber 48 of the reaction vessel 27. The reaction vessel 27 is then sealed with the cover plate 38. The internal environment of the reaction vessel 27 is purged with the carrier gas 1 for 30 minutes at a flow rate of 50 ml/min. Simultaneously, the vessel 27 is heated to about 80° C. and the condensor 12 is cooled to about 4° C. The stirring mechanism is engaged at the maximum velocity permissible by the reaction vessel 27. The electrolysis cell 2 is filled with 2 mM potassium hydroxide. The sodium aluminosilicate drying tubes 14 are placed in an ice bath and the gas trap is placed in liquid nitrogen 16. Data recording devices are set accordingly. The degassed 15 ml of 0.5 M gluconic acid solution 5, pH 7 is injected into the core chamber 48 with the iron powder or metallic material 3. Other organic acids that are comparable to gluconic acid in nature such as ascorbic, oxalic, citric and succinic acids can be used as an alternative. A typical reaction mixture consists of iron powder (25 mg) and 0.5 M degassed gluconic acid solution, pH 7.0. The parameters governing the reaction and the components of the reaction may be varied for optimal results.

Effect of Reaction Parameters on Hydrogen Production

The reaction conditions that are necessary to support the kinetics responsible for metallic iron to serve as a catalyst for the generation of molecular hydrogen gas at the expense of renewable organic acids are:

Iron Mass and Surface Area Ratio

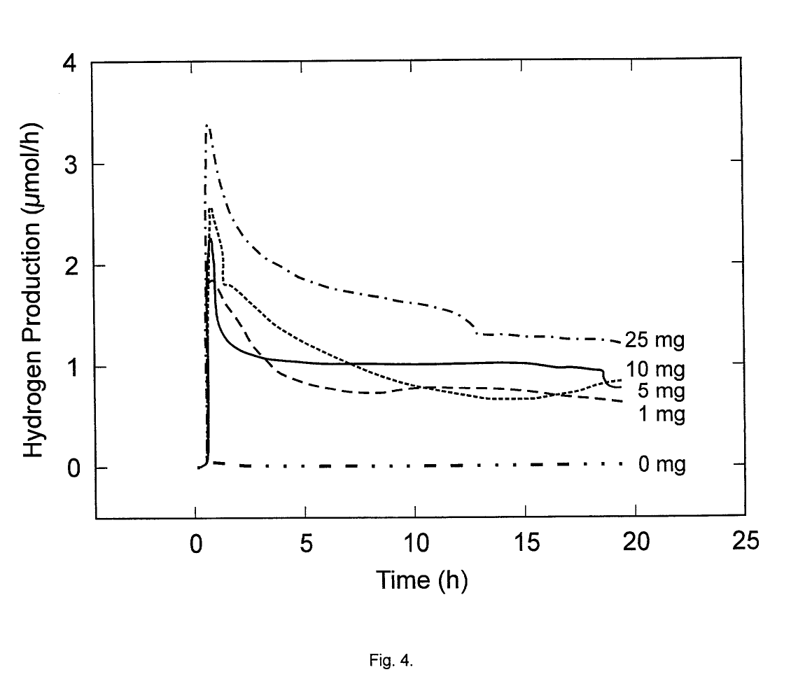

The generation of hydrogen gas is dependent on the amount of the iron accessible for the oxidation reaction. A significant aspect of the iron mass effect is the ratio of accessible surface area-to-mass. The greater this ratio, the greater the rate of production and overall yield of hydrogen. For example, a solid cylinder of iron weighing 10.91 grams with a surface area of 888.84 mm² produced hydrogen at a maximum rate of 0.04 μmol/hr. A sample of iron powder (10 microns) weighing 25 mg with a total surface area of 1.9E+06 mm² is capable of generating hydrogen at a maximum rate of 3.5 μmol/hr. Hydrogen production is increased with iron filings of equal mass-to-surface ratios only when the mass of the iron powder is increased (FIG. 4).

Solution Degassing

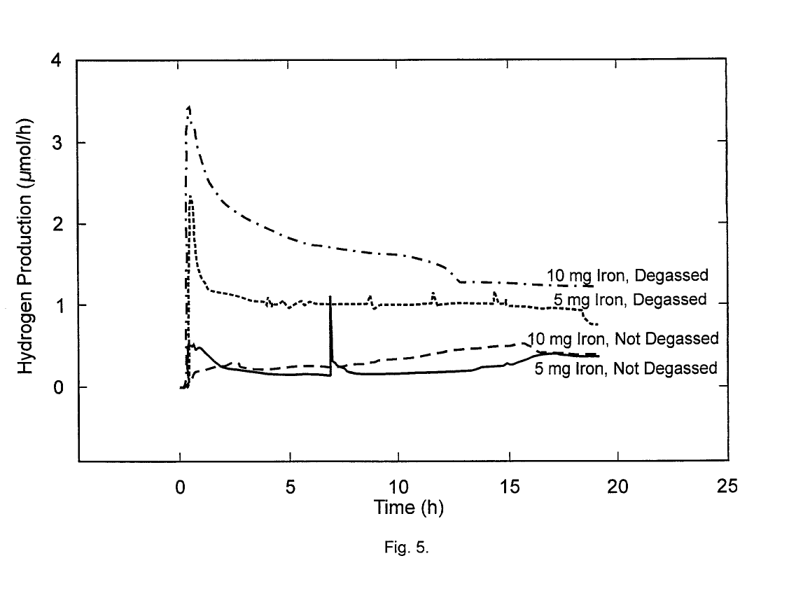

Iron oxidation is the mechanism for the generation of molecular hydrogen gas from the water component of the organic acid solution. The oxygen of the water binds to the iron and subsequently releases the hydrogen molecules. Hydrogen evolution is reduced when free molecular oxygen reacts with iron forming the iron oxide. Therefore, in order to minimize this effect, the solution is placed under vacuum and free oxygen and other gasses are removed prior to the solutions addition to the reaction vessel. The overall assists in maintaining anaerobic conditions. Degassed organic acid solutions have more than double the rates of hydrogen production when compared to the production rates with non-degassed solutions (FIG. 5). In the reaction containing 25 mg of iron powder, the non-degassed Hepes organic acid solution resulted in a peak production rate of 0.5 μmol/hr, where as the degassed solution produced hydrogen at a peak rate of 4.4 μmol/hr.

Stirring Velocity

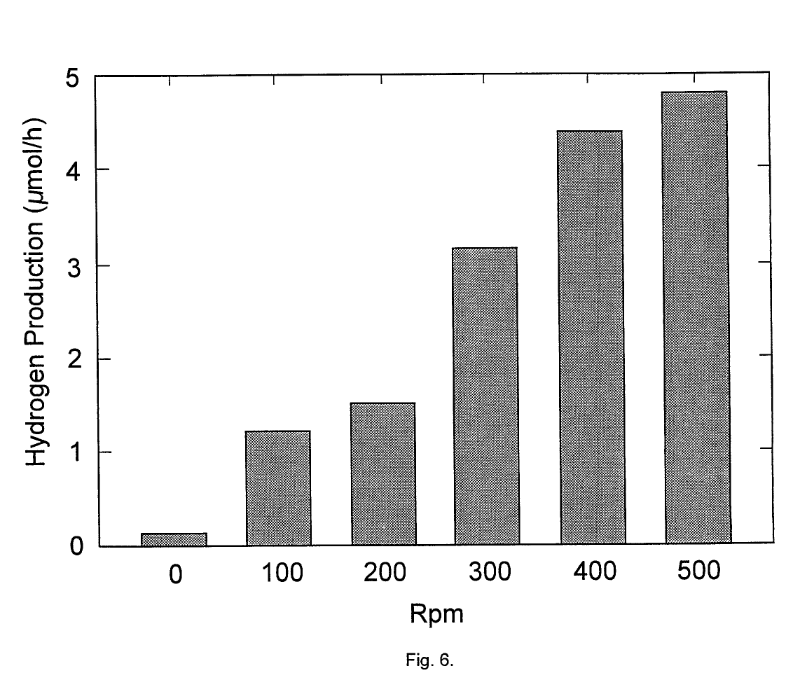

The rate of hydrogen gas production is dependent on the velocity of stirring. Stirring was achieved by use of a magnetic stirring bar (1″) placed into the reaction vessel. The purpose of stirring is to optimize the flow rate by which the solution passes over the surface area of the iron. The iron powder adheres to the end of a magnetic stirring bar. As the bar rotates, the iron powder passes through the solution, optimizing the flow rate of the solution over the iron powder surface area. In conjunction flow of solution, the stirring process continuously mixes the solution in order to keep the organic acid concentration evenly distributed. The stirring velocity is proportional to the rate of hydrogen generation in the overall process (FIG. 6). Without stirring (0 rpm), the rate of hydrogen generation is less than 0.1 μmol/hr. With stirring (500 rpm), the rate of production approaches 5.0 μmol/hr.

Temperature

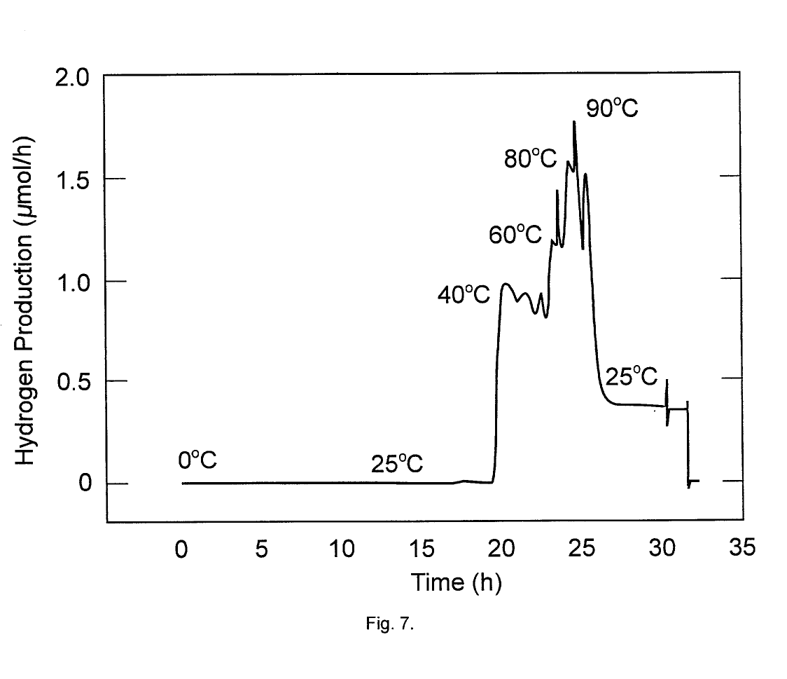

The rate of hydrogen production is dependent on the temperature on the reaction (FIG. 7). There are limitations to the acceptable temperature range that the overall reaction requires at ambient pressure in the system. Temperatures in excess of 80° C. result in solution evaporation and possible organic acid denaturing. Reactions conducted at temperatures below 25° result in little hydrogen production. Temperature selection is based on the greatest production rate and is maintained throughout the entire process.

pH Level

The degree of iron oxidation and reduction for the generation of hydrogen is dependent on the pH of the organic acid solution. Additionally, the effects of the pH are influenced by the amount of free oxygen present in solution. For example, when pH values are less than 4 to 5, iron oxidation rapidly occurs, and at higher oxygen levels the rate of oxidation increases. At these accelerated rates of oxidation (Eq 1), the process of reduction is insignificant (Eq. 2). At pH values 3 and below, such as with citric acid (pH 1.2), oxygen content is irrelevant and total iron oxidation and solubilization occur, the metal catalyst is consumed. When pH values are greater than 5 and oxygen content is exceptionally low, pure iron is resistive to oxidation in various types of water or organic acid solutions. At pH above 9, no reaction occurs. However, in the presence of gluconic acid at pH values near 7.0, iron oxidation and iron reduction processes may occur simultaneously at close to an equivalent rate perhaps. The pH level of the gluconic acid solution during the time of hydrogen production has a minimal increase of 0.1 to 0.2 in pH. The proposed increase is based on the appearance of hydroxide ions in solution.

Selection of Organic Acid

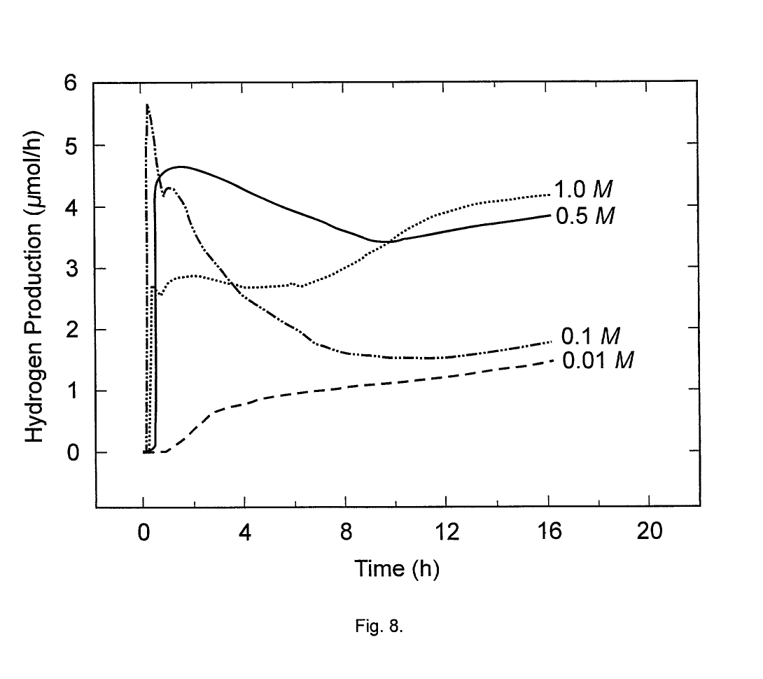

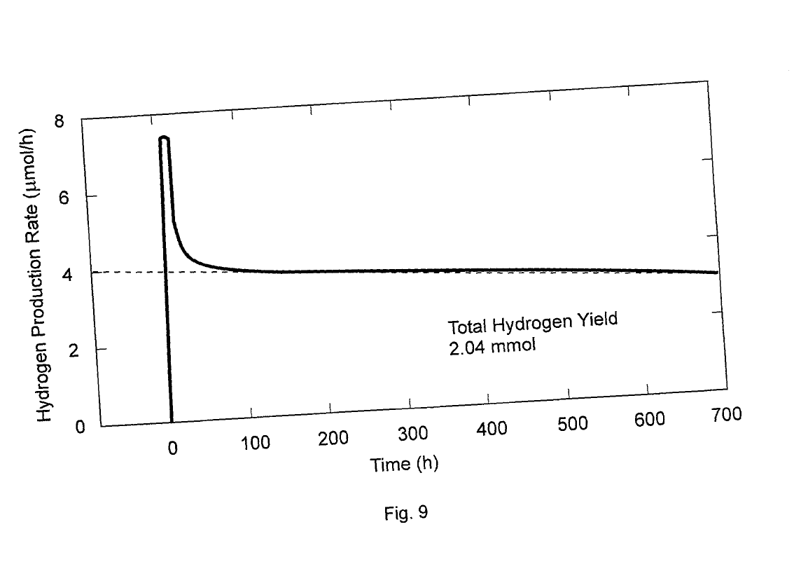

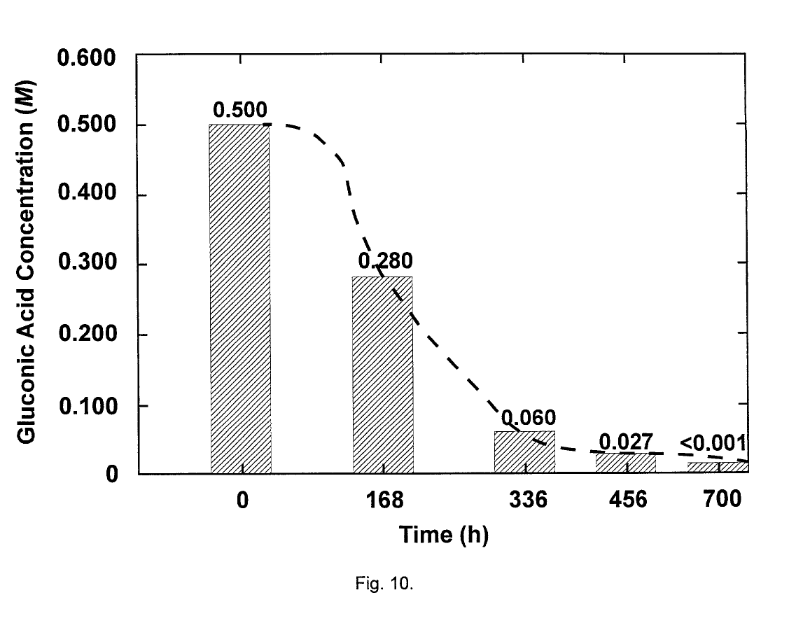

The rate of hydrogen production and subsequent yield of hydrogen is also dependent on the nature of the organic acid that is used in the reaction. The organic acid was selected based on the ability to generate hydrogen at optimal rates, achieve the greatest long-term yields and ability to sustain the catalytic properties of the iron (Table 1). Thus far, gluconic acid has proven to give optimal yields of hydrogen. The optimal concentration of gluconic acid is found to be between 0.5 to 1.0 M (FIG. 8). Greater concentrations tend to prevent the oxidation processes from occurring; whereas lower concentrations do not effectively regenerate the iron in the reduction process. This acid was able to achieve a steady production rate of 4 μmol/hr and maintain this production rate for more than 700 hours (FIG. 9). The reaction described in FIG. 9, the total yield of hydrogen was 2.04 mmol. Gluconic acid (sodium salt) has a natural pH value near 7.0 when dissolved in nanopure water. Therefore, gluconic acid has the ability to regenerate iron (reduce the iron oxide), thus sustaining the catalytic properties of iron. In the present invention, reduction of the iron oxide would consume the gluconic acid. This effect is observed as gluconic acid concentration decreases with time (FIG. 10) and the rate of hydrogen production will decrease with time as well.

TABLE 1
Production of hydrogen using 26 mg iron powder in 15 mL
organic solution for 24 hr.

| | Peak rate of | Sustained rate of |
|---|---|---|
| | hydrogen production | hydrogen production |
| Solution | (μmol/h) | (μmol/h) |
| 0.5 M Gluconic acid, pH ˜7.0 | ˜4.8 | ˜4.1 |
| 0.5 M Absorbic acid, pH ˜7.0 | ˜3.5 | ˜3.5 |
| 0.5 M EDTA, pH ˜7.0 | ˜4.2 | ˜2.4 |
| 0.5 M Hepes buffer solution, | ˜2.1 | ˜1.7 |
| pH ˜7.0 | | |
| 0.5 M Glucose, pH ˜7.0 | ˜1.8 | ˜1.2 |
| 0.5 M Glutamine, pH ˜7.0 | ˜4.8 | ˜0.8 |
| 0.5 M Glutamic Acid, | ˜4.9 | ˜0.7 |
| pH ˜7.0 | | |
| Nanopure water, pH ˜5.6 | ˜4.8 | ˜0.7 |
| Processed water | <0.1 | ˜0.1 |
| 0.5 M Citric acid, pH ˜1.2 | ˜7.0 | <0.1 |
| | | (under 8 h) |

Supportive Data

Several analyses were performed on the reaction components and reaction by-products during and after experiments, discussed below.

Gas Analysis

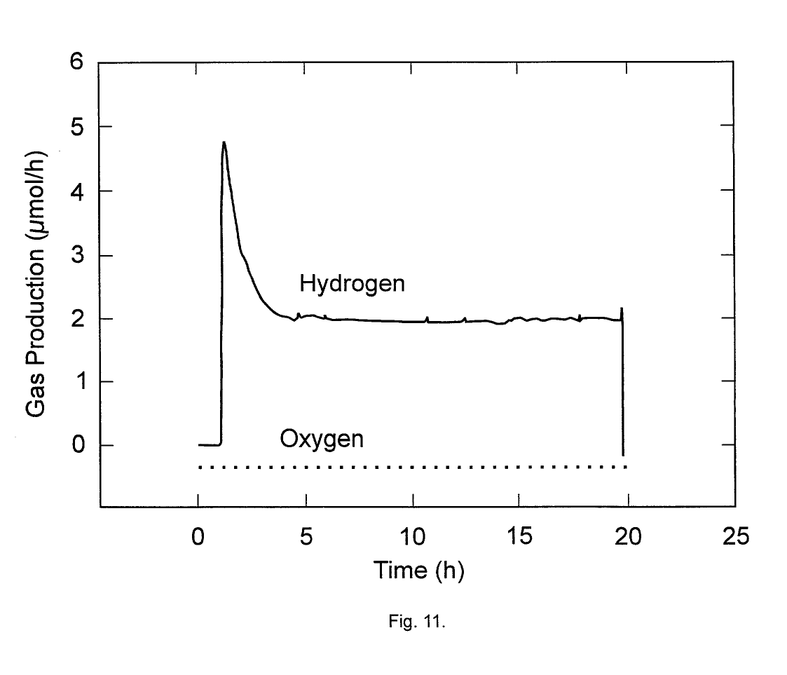

The process of stirring iron powder in an organic acid solution results in the generation of hydrogen gas. The present embodiment of the subject invention above concludes that during the process of hydrogen generation that no additional gases, specifically molecular oxygen, is produced in the reaction. This conclusion is based on experimental data obtained from the utilization of a galvanic cell during the actual hydrogen generating process. The galvanic cell was added to the system of hydrogen analysis immediately following the condenser and data was recorded with the aforementioned ASYST program. The placement of the galvanic cell insures that all carrier or produced gases will pass through the cell. The result of this analysis concludes that as hydrogen gas is generated, molecular oxygen is not produced nor released into the system (FIG. 11). In addition to the galvanic cell analysis for the presence of oxygen, the gas generated within the reaction vessel was analyzed. The hydrogen production reaction was performed in a closed reaction vessel (vacuum-carrier gas free), trapping all generated gases with in the system. Aliquots of the headspace gases were taken and analyzed by mass spectrometry. The gas analysis concludes that hydrogen is the only gas generated in the process of stirring iron powder in gluconic acid solution (Table 2). Hydrogen is found to occupy 70% of the volume and the other gases identified represent percentages found in background air.

TABLE 2
Analysis of head space gas

| | Sample number | | |
|---|---|---|---|
| Gas | 1 | 2 | 3 |
| Xe | <0.1 | <0.1 | <0.1 |
| Kr | <0.1 | <0.1 | <0.1 |
| CO₂ | 0.34 | 0.33 | 0.28 |
| Ar | 0.33 | 0.31 | 0.33 |
| O₂ | 4.77 | 4.53 | 4.90 |
| N₂ | 25.44 | 25.44 | 25.39 |
| H₂ | 68.82 | 70.07 | 68.8 |
| He | 0.28 | 0.30 | 0.38 |
| CH₄ | 0.01 | 0.01 | 0.01 |
| C₂H₆ | 0.01 | 0.01 | 0.01 |

Values are % composition

Mass Balance-iron Solubility Analysis

An accountability analyses was performed to determine if the iron is being consumed or if the iron is serving as a true catalyst in the oxidation/reduction processes outlined above. The first analysis conducted was the solubilization of iron powder in the presence of organic acids. An aliquot of iron powder (101.5 mg) was placed in 22.5 ml of 1.0 M degassed citric acid, pH 1.2. Ninety-nine percent of the iron powder was solubilized in the citric acid solution within 24 hours after which all hydrogen production ceased. At 96 hours the total yield of hydrogen produced was 35.83 umol. Secondly, an iron powder sample (101.3 mg) was placed in 22.5 ml of 1.0 M degassed gluconic acid solution, pH 7.4 for 96 hours. The solubility analysis reports that the concentration of iron in solution accounts for only 1.507% of the total iron powder sample (Table 3). Hydrogen produced was 388 μmol after 96 hours, but it should be noted that hydrogen generation was not complete.

Iron Mass Balance Analysis

An iron powder mass balance analysis was performed in conjunction with the iron solubility analysis. An aliquot of iron powder (99.5 mg) was placed in 22.5 ml of 0.5 M degassed gluconic acid solution, pH 7.4 at 80° C. for 96 hours, satisfying the processes by which hydrogen is generated. After the reaction time, the solution was carefully removed from the reaction vessel. The remaining iron was washed several times with degassed nanopure water and dried under nitrogen gas. The residual iron powder was weighed (97.94 mg). The difference in dry weight equals a 1.567% loss of iron powder (Table 3), equivalent to the iron solubility analysis. In conventional metal displacement reactions, all the metal is consumed. Under anaerobic conditions in the presence of gluconic acid, little of the metal is consumed but hydrogen production is sustained.

TABLE 3
Iron powder accountability

| | | Concen- | | | |
|---|---|---|---|---|---|
| | Initial | tration | Final | | |
| | iron | of iron in | iron | Mass | |
| Experiment | mass | solution | mass | difference | Percent |
| type/solution | (mg) | (mg/L) | (mg) | (mg) | change |
| Solubility/ | 101.5 | ≅4482 | ≅1.079 | ≅100.4 | 98.937 |
| citric acid pH 1.2 | | | | | |
| Solubility/ | 101.3 | ≅69.0 | ≅99.75 | ≅1.53 | 1.507 |
| gluconic acid pH 7.0 | | | | | |
| Mass balance/ | 99.6 | NA | ≅0.0 | ≅99.6 | ≅100.0 |
| citric acid pH 1.2 | | | | | |
| Mass balance/ | 99.5 | NA | 97.94 | ≅1.55 | 1.567 |
| gluconic acid pH 7.0 | | | | | |

Iron Oxide Analysis

Additional analyses were performed on the iron powder, before, during and after the processes of hydrogen production. Data obtained from thermal gravimetric analysis (TGA) on the iron powder prior to mixing with solution in the reaction, reports that the initial sample was 98.91% pure iron and the remaining percentage is a form of iron oxide. The TGA performed on an iron sample 100 hours after mixing in 0.5 M degassed gluconic acid solution, pH 7.4 in the reaction process, reports that 87.9% of the initial iron sample remains as pure iron and the remaining 12.1% is in the form of an iron oxide.

In support of the finds by TGA, Raman spectroscopy was employed to identify the iron oxide formed in the reaction process utilizing samples from the same reaction mixture. Raman spectroscopy analysis identified that the iron oxide as magnetite, Fe₃O₄.

Hydrogen Mass Balance Data

The rate and yield of hydrogen produced by the same mass of iron powder (˜25 mg) under different experimental conditions was determined. The data are shown in Table 4. A typical metal displacement reaction occurs in the presence of citric acid at pH 1.2. After 24 hours in 15 ml 1.0 M or 0.1 M citric acid, pH 1.2 all the iron is dissolved and the maximum yield of hydrogen was 36.6 and 24.3 μmol respectively. However, after 100+ hours in 1.0 M, 0.5 M or 0.1 M gluconic acid, the total hydrogen yield was 107.1, 76.1 or 17.9 μmol respectively. These values did not represent the maximum hydrogen yield possible, as the experiment had not gone to completion (i.e. hydrogen production). These data are very significant in that in the experiments with gluconic acid, little iron had been solubilized and in the case of 0.5 M and 1.0M gluconic acid, the yield of hydrogen was 2-3 fold higher than with citric acid in which all the iron dissolved. Under these conditions, therefore, sustainable hydrogen production is possible with greater yields of hydrogen than in a typical metal displacement reaction.

TABLE 4
Hydrogen mass balance

| | Hydrogen | Total | | |
|---|---|---|---|---|
| | Production | hydrogen | Reaction | Reaction |
| Experimental | “Maximum rate” | yield | complete | time |
| Conditions | (μmol/h) | (μmol/h) | (yes/no) | (h) |
| 1 M Gluconic acid, pH 6.96 | 5.1 | 107.1 | No | 100 |
| 0.5 M Gluconic acid pH 7.1 | 3.8 | 76.1 | No | 100 |
| 0.1 M Gluconic acid pH 6.98 | 3.4 | 17.9 | No | 100 |
| 1 M Citric acid pH 1.2 | 12 | 36.6 | Yes | 24 |
| 0.1 M Citric acid pH 1.2 | 9.8 | 24.3 | Yes | 24 |
| Nanopure water pH 5.6 | 2.3 | 1.8 | No | 100 |

Energy Balance for the Reaction

The standard Gibbs free energy of formation (Δ_{f}G°) was determined for the hydrogen production process involving iron powder as an active catalyst in gluconic acid solution. The complete hydrogen production reaction has an optimal yield when the system is maintained at 80° C. (a parameter previously described). The heat applied to the system serves as an activation energy requirement for the reaction. Converting the applied heat to Gibbs free energy, ˜338 kJ/mol was obtained using the following equation:

ΔG(kJ/mol)=Δ_{f}H°(kJ/mol)−S(kJ/mol⁻¹°K⁻¹)*ΔT(°K)

From Eq. 1, hydrogen production via process of iron oxidation, the Gibbs free energy was ˜67 kJ/mol, based on the following equations and data presented in Table 5:

Δ_{f}G°(reaction)=_{f}G°Σ(products)−_{f}G°Σ(reactants)

From Eq. 2, iron catalyst regeneration via iron oxide reduction by gluconic acid, the standard Gibbs Free energy of formation was determined as accurately as possible, via bond dissociation energy calculations based on the thermodynamic data of glucose and citric acid. The Gibbs free energy was determined to be ˜−869kJ/mol (Table 5).

The energy balance of the hydrogen production reactions was calculated by summing the Gibbs free energies for the heat of activation, formation for iron oxide and the reduction of the iron oxide.

ΔG°(reaction)=ΔG°(heat of activation)+ΔG°(iron oxidation)+ΔG°(iron oxide reduction)

ΔG°(reaction)≅338+−66.7+−869≅−596.7 kJ/mol

The summation of the Gibbs free energy for the reaction is negative. Therefore the reaction is exothermically favorable.

The Gibbs free energy was also calculated for the combustion of the hydrogen gas. The Gibbs free energy was ˜−914 kJ/mol, based on the following reaction:

4H₂+2O₂→4H₂O

The energy balance of the overall hydrogen production process, including hydrogen combustion is:

ΔG°(reaction)≅−1511 kJ/mol

TABLE 5
Chemical thermodynamic data of reaction components

| | Δ_{f}H°(kJ/mol) | Δ_{f}G°(kJ/mol) |
|---|---|---|
| Fe | 0 | 0 |
| H₂O | −285.83 | −237.179 |
| Fe₃O₄ | −1118.4 | −1015.4 |
| H₂ | 0 | 0 |
| C₆H₁₁O₇ | −1275 | −943 |
| C₆H₁₀O₇ | −1433 | −1060 |
| O₂ | 0 | 0 |

Additional Reaction Vessel Design for Collection of Large Volumes of H₂

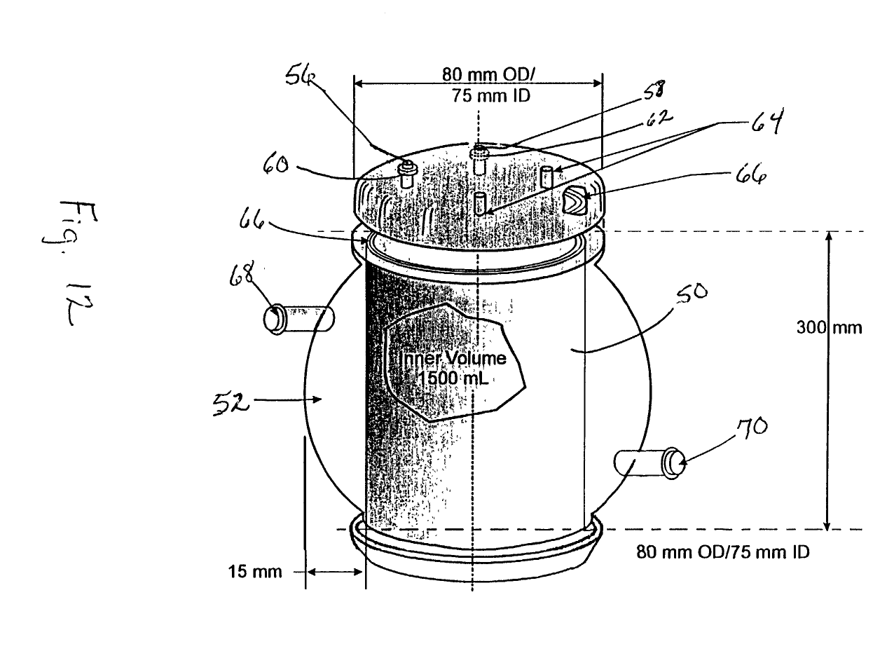

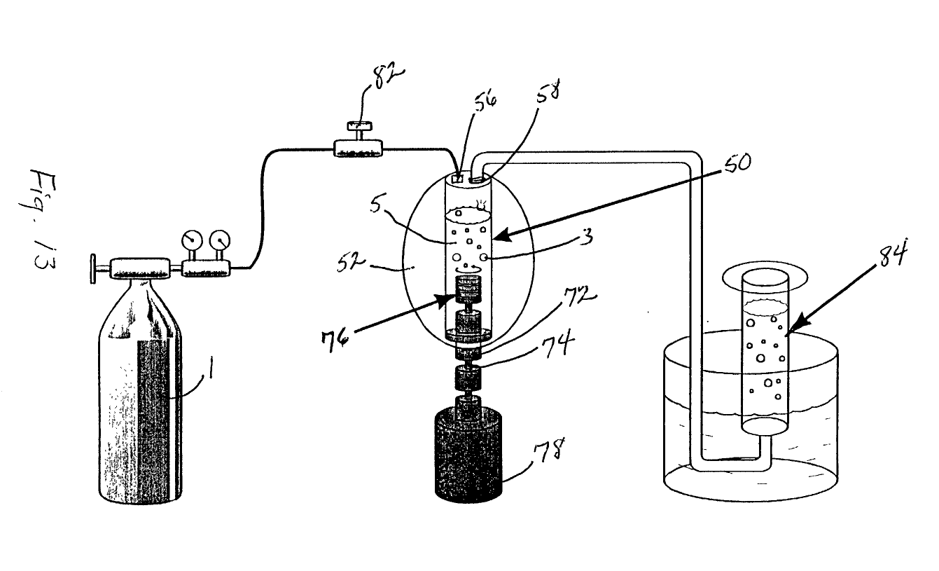

The 1.5L reaction vessel is of similar design (FIG. 12). There is a cover plate 54 with multiple ports, a gas inlet 56 having o-ring 60, a gas outlet 58 having o-ring 62 and solution injection/extraction ports 64. The cover plate 54 is sealed when positioned on the reaction vessel 50. FIG. 12 shows an o-ring 66 between the cover plate 54 and the reaction vessel 50. There is a thermal heating system applied to the exterior as the outer core vessel 52. The outer core vessel 52 has a thermal heating jacket inlet 68 and a thermal heating jacket outlet 70. FIG. 13 shows that the 1.5L reaction vessel design 50 consists of an internal stirring blade system 76 that is connected to an external motor 78. The stirring blades 76 are fixed to a drive shaft 74. The drive shaft 74 is passed through a liquid/gas impermeable seal system 80 constructed of Teflon and rubber. The liquid/gas seal 80 and bearing assembly is fixed (pressed) in to the machined bearing-housing assembly 72. The bearing-housing assembly 72 is securely fastened to the upper scale reaction vessel 50. The external end of the drive shaft 74 is connected to the motor 78, which can be operated at selected velocities. The overall hydrogen production system and process comprise purging gas (e.g. helium) 1 flowing into the reaction vessel 50 through gas inlet 56, the reaction vessel having an outer core vessel 52, the metal catalyst 3 and the degassed aqueous organic acid solution 5 within the reaction vessel reacting thus generating hydrogen, the purging gas and generated hydrogen gas flowing out through the gas outlet 58 to a hydrogen collection device or apparatus 84. The purging gas 1 is controlled by the on/off valve 82. The method supporting the hydrogen production is the same as previously described, minus the carrier gas (EXAMPLE 1). The hydrogen produced in the reaction was collected and analyzed. Hydrogen was collected at a maximum rate of 3.4 ml/min for a total yield of 589 ml, collected for 52.5 hours. Additionally, the gas analysis indicates that the hydrogen was the only gas produced. For all experiments and EXAMPLES, iron powder was purchased from Aldrich (Milwaukee, Wis.), gluconic acid was from Sigma Chemical Co. (St. Louis, Mo.) and molecular sieves from Aldrich (Milwaukee, Wis.).

### EXAMPLE 1

Using the above described apparatus with a 1.5 L reaction vessel, 5 g of iron powder was reacted with 1 L degassed 0.5 M gluconic acid at pH 7.4 and 80° C. Constant stirring took place at 400 rpm. No carrier gas was used.

Other Alternative Embodiments

The metal catalyst can also be fixed to a surface within the reaction vessel, then the acid solution is forced over the catalyst at various rates. Also, the catalyst can be applied as a solid, such as a wire or mesh type system. These are examples of ways to reduce the amount of metal catalyst suspended in solution during the stirring process.

In addition, scaling the reaction vessel size in order to contain more organic acid solution and/or catalyst may increase the rate of hydrogen production. Alternatively, the increase in hydrogen production could come from modular reaction vessels, several small reactors connected together. The concept of scaling is to design a self-sustaining system for the production of hydrogen gas. Another version includes the use of a designed turbine that operates under anaerobic conditions at 1500-2500 rpm. The turbine contains the metal catalyst and the organic acid solution.

Application of Hydrogen Production

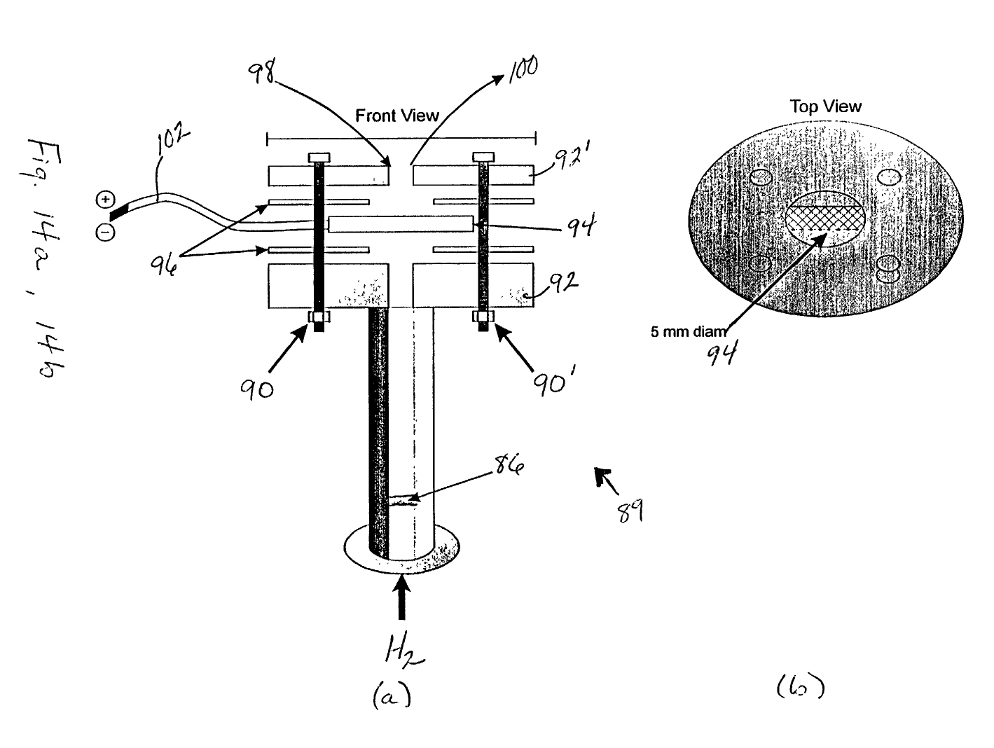

Applying the hydrogen produced utilizes the 15 ml reaction vessel and replaces the tin dioxide hydrogen sensor with a small hydrogen fuel cell. The conversion of generated hydrogen into useable energy has been successfully completed, see EXAMPLE 2, FIG. 14a and FIG. 14b.

### EXAMPLE 2

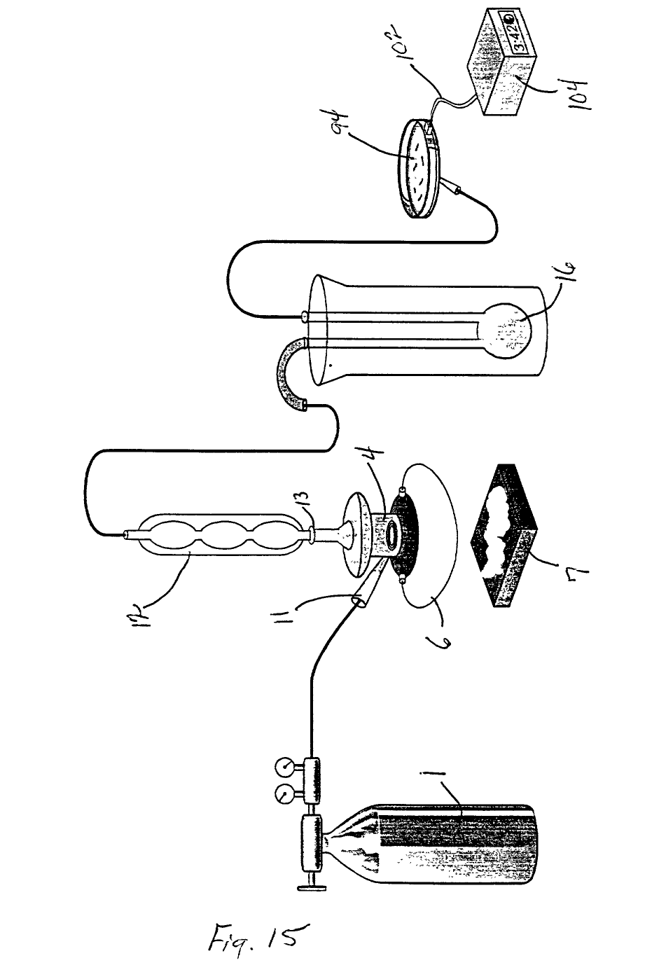

A housing device 89 was designed and assembled specifically for the fuel cell 94, see FIG. 14a (front view). The hydrogen gas flowed into the housing device 89 first passing through a glass frit 86. The housing device 89 comprised a first glass disc 92 and a second glass disc 92′ with a fuel cell 94 sandwiched in between the two glass discs 92 and 92′. Rubber seals 96 were placed between the glass discs 92, 92′ and the fuel cell 94. The housing device 89 was held together by lock-down bolts 90 and 90′. The housing device 89 had a gas inlet for atmospheric oxygen 98 and a gas outlet for the excess hydrogen gas 100 that can be used to be recycled back to the reaction step in the reaction vessel. The housing device 89 was connected to a digital clock by wire 102. FIG. 14b shows a top view of the fuel cell 94, 5 mm in diameter. From FIG. 15, it can be seen that the hydrogen fuel cell 94 was connected to the reaction system after the liquid nitrogen gas trap 16, in place of the hydrogen sensor. FIG. 15 illustrates the helium carrier gas 1 flowed into the gas inlet 11 into the reaction vessel 4, FIG. 15 also showing the thermal loop 6. The gas then flowed through the gas outlet 13 into the condenser 12 into the liquid nitrogen gas trap 16 and into the fuel cell 94. The fuel cell 94 generated current, which was carried by wire 102 to the digital clock 104. The digital clock 104 operated on 5 μamp. The reaction started with 265 mg iron reacted with 15 mL degassed 0.5 M gluconic acid, pH 7.2 at 80° C. with stirring at 400 rpm, helium carrier gas was flowing at a rate of 5 mL/min. The digital clock was powered for 32 consecutive days, after which the rate hydrogen production decreased below that which would sustain powering the clock.

Use of Hydrogen Production for Customized Micro- and Macro-power Sources

Micro-power sources can be used for low power (current) requiring electronic devices that could be placed in the environment for at least 1 year for sensing operations. They would also be portable and extremely light to carry and could generate power upon demand. Applications include audio/video equipment, cameras, communications, electronics, musical instruments and cellular phones. In view of escalating oil prices and potential shortages as well as the environmental consequences of hydrocarbon combustion, a macro-power system built on the methodology of Applicant's invention could prepare the military for a long-term sustainable energy supply around which could be built aircraft as well as other military vehicles. The benefits could also include the deployment of energy efficient cost effective power systems for providing light in work areas and living quarters. Military and non-military waste iron for hydrogen generation could also be utilized.

As discussed previously, a mixture of iron powder and an organic acid results in the evolution of hydrogen gas under ambient conditions. Depending on the conditions, this reaction forms the basis of micro- and macro-power sources for multiple applications. In a system enclosed by a fuel cell, part of the hydrogen is used to generate current (depending on the current drain), while excess hydrogen reduces solubilized iron back to the metal which can react further with the organic acid to produce more hydrogen. The rate of hydrogen generation can be controlled by the pH and nature of the organic acid used (previously discussed) and, therefore, power sources customized to generate a required current can be constructed. The hydrogen generated could result in the generation of Kw-h of power at a cost of a few cents.

The mechanism is given by the examples below:

Fe+2CH₃COOH [symbol] Fe₂⁺(COO⁻)₂+H₂

Fe+2C₆H₁₁O₇ [symbol] Fe₂⁺(C₆H₁₀O₇⁻)₂+H₂

Micro-power Generating System

### EXAMPLE 3

A system having a solid/liquid volume of 5.0 ml comprises 0.1 g iron (Fe) powder (1.8 mmol) in 5% acetic acid. Based on Faraday's Law, generation of 5 μamps of current requires the production of 15.5×10⁻¹⁰ mol/min H₂. Since 1.8 mmol Fe generates an equimolar amount of hydrogen, then equipment with a current drain of 5 μamps or 5 μamps could run for 806 or 0.806 days respectively. The rate of H₂ generation would need to be 0.093 or 93 μmol/h. Maximum power generation =0.116 watt-h, depending on the efficiency of the fuel cell. This is based on the consumption of 1 mol H₂by a fuel cell generating 237.1 kJ of free energy for a power requiring process.

### EXAMPLE 4

A system having a solid/liquid volume of 5.0 ml comprises 1.0 g Fe powder (18 mmol) in 43% acetic acid. Based upon Faraday's Law, generation of 1200 mA of current requires the production of 372 μmol/min H₂. Since 18 mmol Fe generates an equimolar amount of hydrogen, then equipment with a current drain of 1200 mamps (e.g. cellular phone) could run for 48 minutes. Maximum power generation =1.16 watt-h.

Macro-power Generating System

### EXAMPLE 5

This is identical to EXAMPLE 1 described above except that the system is 3 orders of magnitude larger. Maximum power production =116 watt-h.

### EXAMPLE 6

This is identical to EXAMPLE 2 described above except that the system is 3 orders of magnitude larger. Maximum power production =1.16 kwatt-h.

On a 30 day mission consisting of a 4-6 man team, each team member carries approximately 12.7 kg of batteries. This can be reduced by an order of magnitude.

### EXAMPLE 7

A power pack or power cell comprising 0.5 kg (8.98 mol) Fe in 99% acetic acid (1 L) generates 8.98 mol H₂. For a current drain of 1.2 amp (3.72×10⁻⁴ mol H₂/min), the battery would last for 16 days. Maximum power production =5.915 kwatt-h.

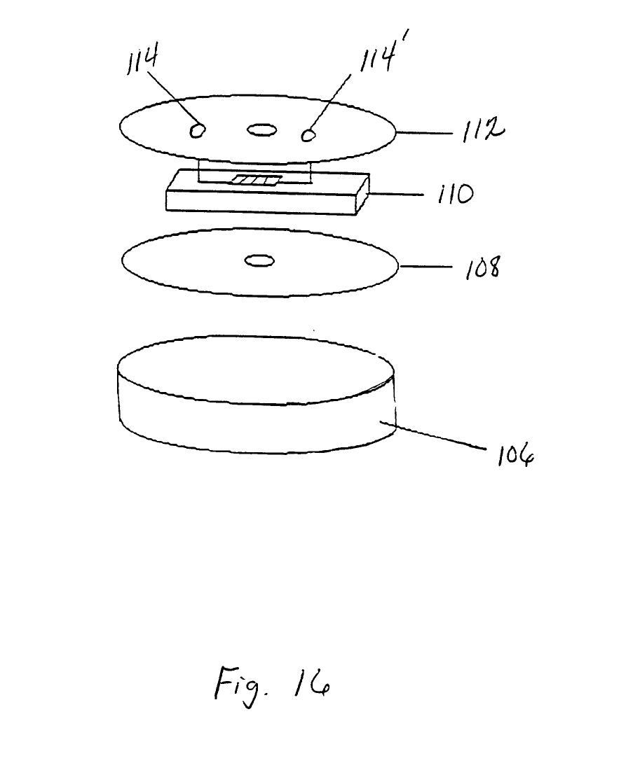

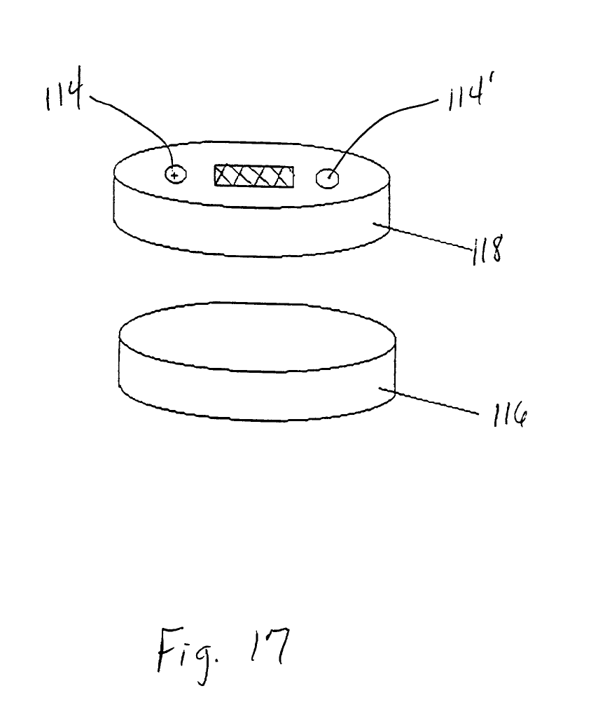

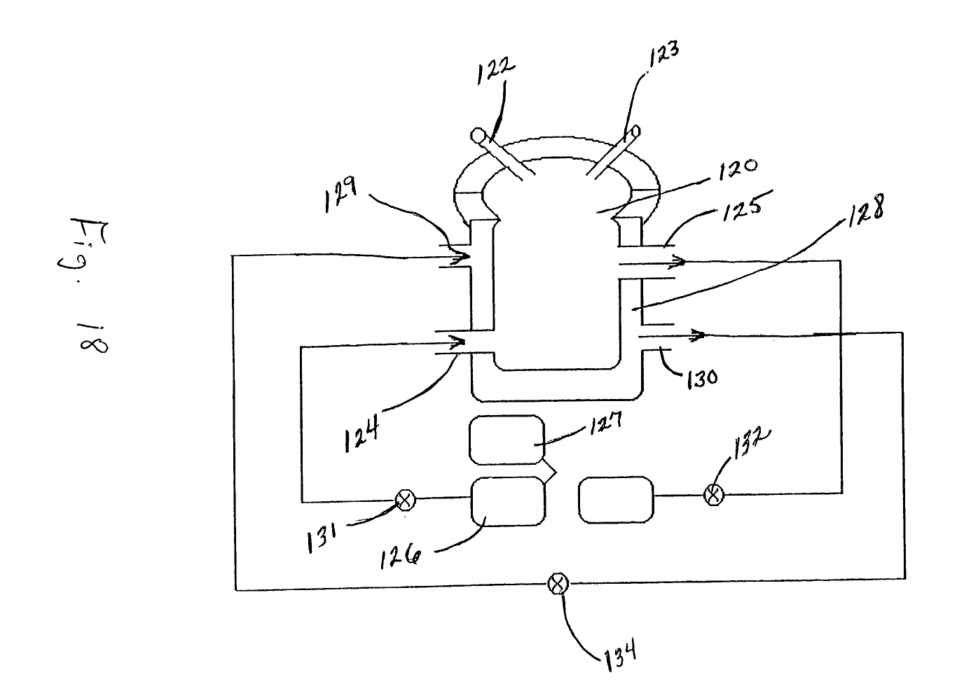

FIG. 16 shows a hydrogen fuel cell having an enclosed power source system whereby the reactants or reactant components are contained within a small (5 mL) reaction chamber 106 where the reaction takes place and hydrogen is produced. The hydrogen is diffused by a glass frit cover plate 108 into a fuel cell 110 having positive and negative electrodes 114, 114′ that are used to generate current by converting the hydrogen gas into usable energy. FIG. 16 also shows a cover plate 112 to the hydrogen fuel cell. FIG. 17 shows a prototype of a power cell having an enclosed fuel cell 118 and reaction chamber within the power cell unit 116. FIG. 17 also shows electrodes 114 and 114′ for converting hydrogen to energy by generating current. Another embodiment includes that shown in FIG. 18 which is a system for the continuous and sustained production of hydrogen. FIG. 18 shows a reaction vessel 120 containing reaction components, metal catalyst and degassed aqueous organic acid solution, under anaerobic conditions. The reaction vessel 120 has a carrier gas inlet port 122 to allow a carrier gas to enter the reaction vessel, then pass over the reaction components and exit the reaction vessel via a carrier gas outlet port 123, carrying with it the hydrogen produced within the reaction vessel. The reaction vessel 120 also has a solution inlet port 124 which allows a controlled flow of a predetermined amount of degassed stock solution of aqueous organic acid solution to enter the reaction vessel 120, from the stock solution reservoir 126. The supply of stock solution continuously feeds the reaction within the reaction vessel, thereby sustaining the reaction and sustaining the continuous production of hydrogen. The reaction and production of hydrogen continues until the stock solution is depleted within the stock solution reservoir 126. The stock solution flow is controlled by pump 131. FIG. 18 also shows where helium gas 127 flows with the stock solution to fill the head space since the stock solution has been degassed wherein all oxygen has been removed. The reaction vessel 120 also has a solution outlet port 125, which allows the excess solution within the reaction vessel to exit to a waste solution reservoir 127 via pump 132. The reaction vessel is contained within a closed outer thermal heating jacket 128 having a thermal heating jacket inlet port 129 and a thermal heating jacket outlet port 130. The flow through the closed thermal heating jacket is controlled and heated by pump 134.

While there has been shown and described what are at present considered the preferred embodiments of the invention, it will be obvious to those skilled in the art that various changes and modifications can be made therein without departing from the scope of the inventions defined by the appended claims.

What is claimed is:

1. An energy-producing device powered by a system for the continuous production of hydrogen comprising:
a) a reaction chamber adapted for supporting and maintaining an anaerobic environment, said reaction chamber containing reactant components whereby hydrogen is continually produced upon said reactant components reacting with one another;
b) a fuel cell adjacent said reaction chamber wherein said hydrogen produced within said reaction chamber is diffused into said fuel cell to be used as fuel for generating energy, said fuel cell having a positive electrode and a negative electrode for converting said hydrogen into energy.

2. The energy-producing device according to claim 1 wherein said energy-producing device is a heat engine.

3. The energy-producing device according to claim 1 wherein said energy-producing device is a power cell.

4. The energy-producing device according to claim 1 wherein said reactant components comprise a metal catalyst and a degassed aqueous solution of an organic acid.

5. An energy-producing device comprising:
a) a reaction chamber enclosed within a housing, said reaction chamber adapted for supporting and maintaining an anaerobic environment, said reaction chamber containing reactant components whereby hydrogen is continually produced upon said reactant components reacting with one another;
b) a fuel cell enclosed within said housing, said fuel cell contiguous with said reaction chamber wherein said reaction chamber is open to said fuel cell and whereby said hydrogen produced within said reaction chamber diffuses into said fuel cell to be used as fuel for generating energy, said fuel cell having a positive electrode and a negative electrode for converting said hydrogen into energy.

6. The energy-producing device of claim 5 wherein said energy-producing device is a power cell.

7. The energy-producing device of claim 5 wherein said reactant components comprise a metal catalyst and a degassed aqueous solution of an organic acid.

8. A hydrogen-generating system for the continuous and sustained production of hydrogen fuel comprising:
a) a reaction vessel adapted for supporting and maintaining an anaerobic environment, said reaction vessel containing reactant components whereby hydrogen is continually produced upon said reactant components reacting with one another, said reaction vessel having a carrier gas inlet port to allow a carrier gas to enter said reaction vessel and a carrier gas outlet port to allow said carrier gas and said hydrogen produced from said reaction to exit said reaction vessel, said reaction vessel further having a solution inlet port to allow a continuous flow of a stock solution to enter said reaction vessel to continuously feed said reaction for the continuous and sustained production of hydrogen, and said reaction vessel having a solution outlet port to allow an overflow of excess solution within said reaction vessel to exit said reaction vessel;
b) a stock solution reservoir for containing said stock solution, said stock solution reservoir in fluidic communication with said reaction vessel;
c) a waste solution reservoir for receiving said overflow of excess solution exiting said reaction vessel, said waste solution reservoir in fluidic communication with said reaction vessel; and
d) a thermal means enveloping said reaction vessel for maintaining a constant reaction temperature within said reaction vessel.

9. An energy-producing device powered by a system for the continuous and sustained production of hydrogen comprising the hydrogen-generating system of claim 8 and further comprising a fuel cell adjacent said reaction vessel wherein said hydrogen produced within said reaction vessel exits said reaction vessel through said carrier gas outlet port and diffuses into said fuel cell to be used as fuel for generating energy, said fuel cell having a positive electrode and a negative electrode for converting said hydrogen into energy.

10. The energy-producing device of claim 9 wherein said energy-producing device is a power cell.

11. The energy-producing device of claim 9 wherein said energy-producing device is a heat engine.

12. The energy-producing device of claim 9 wherein said reactant components comprise a metal catalyst and a degassed aqueous solution of an organic acid.
